(19) United States
(12) Patent Application Publication
(10) Pub. No.: US 2018/0056875 A1
(43) Pub. Date: Mar. 1, 2018

(54) Self-Adjusting Vehicle Mirrors

(71) Applicant: GM GLOBAL TECHNOLOGY OPERATIONS LLC, Detroit, MI (US)

(72) Inventors: Luis M. Goncalves, Farmington Hills, MI (US); Brunno L. Moretti, Walled Lake, MI (US)

(21) Appl. No.: 15/251,667

(22) Filed: Aug. 30, 2016

(51) Int. Cl. B60R 1/02; B62D 15/02

(52) U.S. Cl. CPC B60R 1/025; B62D 15/021

(57) ABSTRACT

Methods and systems to control a position of a reflective surface of a mirror of a vehicle are disclosed. The method includes providing the vehicle with at least one sensor configured to measure at least one vehicle characteristic and a controller in electronic communication with the at least one sensor; receiving, by the controller, vehicle data corresponding to the at least one vehicle characteristic from the at least one vehicle sensor; calculating, by the controller, a reflective surface adjustment based on the vehicle data; and automatically controlling, by the controller, the actuator to change the position of the reflective surface of the mirror from a first position to a second position based on the reflective surface adjustment.

### INTRODUCTION

The present invention relates generally to the field of vehicles and, more specifically, to self-adjusting vehicle mirrors to improve visibility.

As a vehicle makes a turn, visibility behind and to the sides of the vehicle through the side-mounted rear view mirrors can be compromised. Side and rear visibility can be especially challenging for tow vehicles, such as tow trucks or vehicles towing trailers, boats, other vehicles, etc., as the vehicle initiates and completes a turn or travels on a winding road.

### SUMMARY

Embodiments according to the present disclosure provide a number of advantages. For example, embodiments according to the present disclosure enable higher visibility of the area behind and to the side of the vehicle when driving on a curved road and/or making turns. Embodiments according to the present disclosure may thus provide more robust visibility to the vehicle operator, increasing customer satisfaction.

In one aspect, a method to control a position of a reflective surface of a mirror of a vehicle is disclosed. The method includes the steps of providing the vehicle with at least one sensor configured to measure at least one vehicle characteristic and a controller in electronic communication with the at least one sensor; receiving, by the controller, vehicle data corresponding to the at least one vehicle characteristic from the at least one sensor; calculating, by the controller, a reflective surface adjustment based on the vehicle data; and automatically controlling, by the controller, the actuator to change the position of the reflective surface of the mirror from a first position to a second position based on the reflective surface adjustment.

In some aspects, the method further includes determining, by the controller, whether the vehicle is negotiating a turn based on the vehicle data. In some aspects, the at least one sensor includes a steering angle sensor and the vehicle data is a steering angle of the vehicle. In some aspects, the at least one sensor includes a gyroscope and the vehicle data is gyroscopic data of the vehicle. In some aspects, the at least one sensor includes one or more of an optical, RADAR, and LIDAR sensor and the vehicle data includes one or more of optical, RADAR, and LIDAR images of an environment surrounding the vehicle. In some aspects, the method further includes receiving, by the controller, navigation data corresponding to a location of the vehicle and determining, by the controller, whether the vehicle is negotiating a turn based on the navigation data. In some aspects, the reflective surface adjustment is a predetermined value. In some aspects, the method further includes determining, by the controller, whether the vehicle has completed negotiation of the turn based on the vehicle data and automatically controlling, by the controller, the actuator to change the position of the reflective surface of the mirror from the second position to the first position.

In another aspect, an automotive vehicle includes a vehicle steering system; at least one sensor electrically connected to the vehicle steering system and configured to measure at least one vehicle characteristic; a mirror coupled to a side of the vehicle, the mirror including a housing and a reflective surface selectively positionable between a first position and a second position; an actuator in communication with the reflective surface of the mirror; and a controller in communication with the sensor and the actuator, the controller configured to receive vehicle data corresponding to at least one vehicle characteristic from the at least one sensor; calculate a reflective surface adjustment based on the vehicle data; and automatically control the actuator to change the position of the reflective surface of the mirror from a first position to a second position based on the reflective surface adjustment.

In some aspects, the at least one sensor includes one or more of a steering angle sensor, a gyroscope, an optical sensor, a RADAR sensor, and a LIDAR sensor. In some aspects, the controller is further configured to determine whether the vehicle is negotiating a turn based on the vehicle data. In some aspects, the reflective surface adjustment is a predetermined value. In some aspects, the controller is further configured to determine whether the vehicle has completed negotiation of the turn based on the vehicle data and automatically control the actuator to change the position of the reflective surface of the mirror from the second position to the first position.

In yet another aspect, a system for automatically adjusting a reflective surface of a vehicle mirror is disclosed. The system includes an actuator configured to control a position of the reflective surface of the vehicle mirror, the reflective surface selectively positionable between a first position and a second position; a sensor configured to measure a vehicle characteristic; and a controller in communication with the actuator and the sensor, the controller configured to automatically control the actuator to change a position of the reflective surface from the first position to the second position based on the measured vehicle characteristic.

In some aspects, the sensor is a steering angle sensor configured to measure a vehicle steering angle. In some aspects, the controller is further configured to determine whether the vehicle is negotiating a turn based on the steering angle. In some aspects, the controller is further configured to calculate a reflective surface adjustment based on the steering angle. In some aspects, the reflective surface adjustment is a predetermined value. In some aspects, the controller is further configured to determine whether the vehicle has completed negotiation of the turn based on the measured vehicle characteristic and automatically control the actuator to change the position of the reflective surface of the mirror from the second position to the first position.

### BRIEF DESCRIPTION OF THE DRAWINGS

The present disclosure will be described in conjunction with the following figures, wherein like numerals denote like elements.

FIG. 1 is a schematic diagram of a vehicle with self-adjusting mirrors, according to an embodiment.

FIG. 2 is a schematic diagram of a vehicle, such as the vehicle of FIG. 1, illustrating a viewing position adjustment of a side-mounted rear view mirror, according to an embodiment.

FIG. 3 is a schematic block diagram of a mirror position control system for a vehicle such as the vehicle of FIG. 1, according to an embodiment.

FIG. 4 is a flow chart of a method to adjust a viewing position of a mirror, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

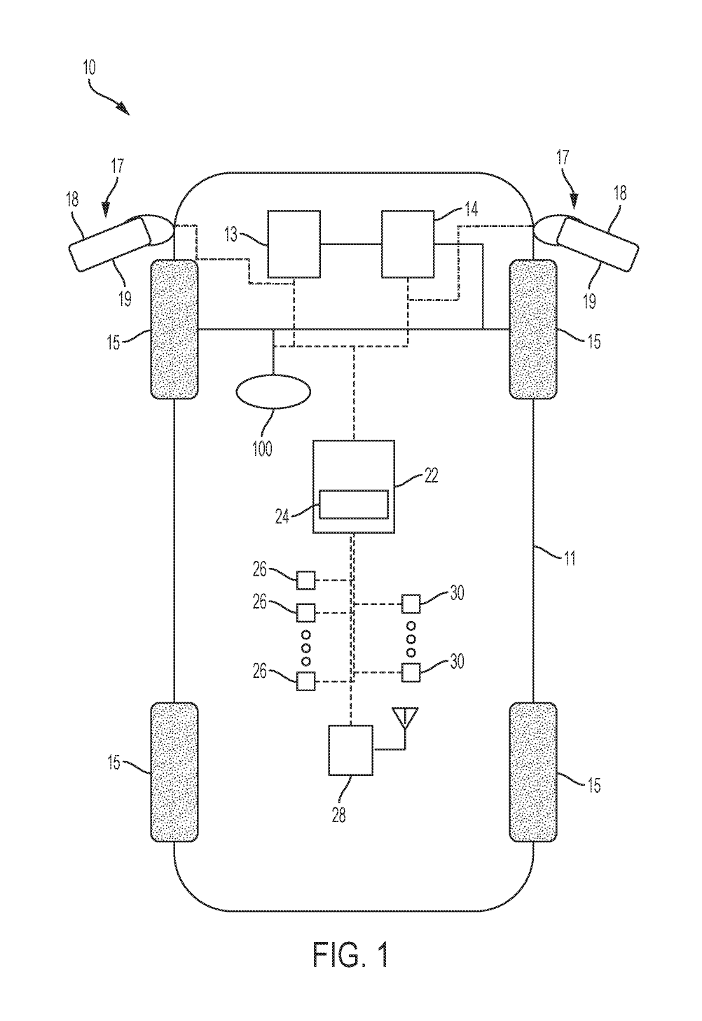

FIG. 1 schematically illustrates an automotive vehicle 10 according to the present disclosure. The vehicle 10 generally includes a body 11 and wheels 15. The body 11 encloses the other components of the vehicle 10. The wheels 15 are each rotationally coupled to the body 11 near a respective corner of the body 11. The vehicle 10 further includes side-mounted rear view mirrors 17 coupled to the body 11. Each of the side-mounted rear view mirrors or mirrors 17 includes a housing 18 enclosing a selectively positionable reflective surface 19. The reflective surfaces 19 of the mirrors 17 provide rear and/or side visibility to the operator of the vehicle 10 on one or both sides of the vehicle. The vehicle 10 is depicted in the illustrated embodiment as a passenger truck, but it should be appreciated that any other vehicle, with or without a trailer, including motorcycles, cars, sport utility vehicles (SUVs), or recreational vehicles (RVs), etc., can also be used. Additionally, while the figures illustrate adjustment of the side-mounted rear view mirrors 17 of the vehicle 10, the methods and systems disclosed herein could also be applied to adjustment of other mirrors, cameras, or sensors of the vehicle 10, such as a side-mounted camera, a rear view mirror, or other examples.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems.

The vehicle 10 additionally includes a steering system 16. While depicted as including a steering wheel and steering column for illustrative purposes, in some embodiments, the steering system 16 may not include a steering wheel. In various embodiments, the vehicle 10 also includes a navigation system 28 configured to provide location information in the form of GPS coordinates (longitude, latitude, and altitude/elevation) to a controller 22. In some embodiments, the navigation system 28 may be a Global Navigation Satellite System (GNSS) configured to communicate with global navigation satellites to provide autonomous geo-spatial positioning of the vehicle 10. In the illustrated embodiment, the navigation system 28 includes an antenna electrically connected to a receiver.

With further reference to FIG. 1, the vehicle 10 also includes a plurality of sensors 26 configured to measure and capture data on one or more vehicle characteristics, including but not limited to vehicle speed, steering angle, and vehicle heading. In the illustrated embodiment, the sensors 26 include, but are not limited to, an accelerometer, a speed sensor, a heading sensor, gyroscope, steering angle sensor, or other sensors that sense observable conditions of the vehicle or the environment surrounding the vehicle and may include RADAR, LIDAR, optical cameras, thermal cameras, ultrasonic sensors, and/or additional sensors as appropriate. The vehicle 10 also includes a plurality of actuators 30 configured to receive control commands to control steering, shifting, throttle, braking, mirror position or position of a reflective surface of a mirror, or other aspects of the vehicle 10, as discussed in greater detail below.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

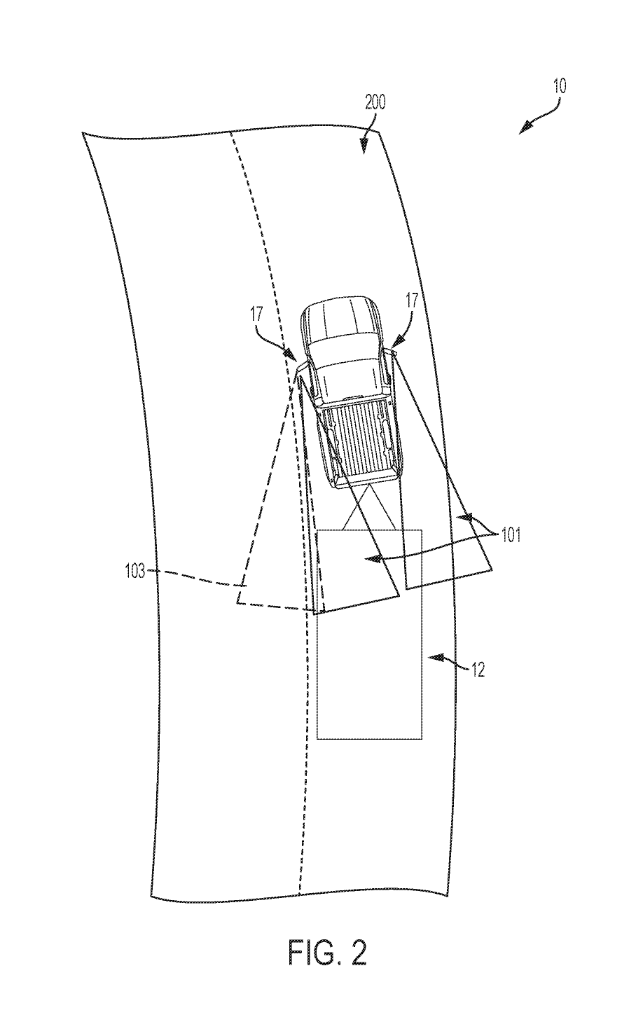

FIG. 2 schematically illustrates the vehicle 10 traveling along a road 200 having a curve or turn. For vehicles, such as the vehicle 10, illustrated as towing a trailer 12, the position of the reflective surface 19 of the mirrors 17 may not provide sufficient rear and side visibility. For vehicles towing a trailer, the trailer 12 following behind the vehicle 10 may obscure rear and/or side visibility, particularly as the vehicle 10 enters a curve or completes a turn. Areas 101 illustrate the side and rear area viewable to the operator when the reflective surfaces 19 are in a first, or original, position. While FIG. 2 illustrates a vehicle 10 towing a trailer 12, the methods and systems discussed herein for adjusting the reflective surface 19 of the mirrors 17 are applicable to any type of vehicle, with or without a trailer, such as motorcycles, cars, sport utility vehicles (SUVs), or recreational vehicles (RVs). As shown in FIG. 2, as the vehicle 10 negotiates a left-hand curve, the area 101 on the left side of the vehicle 10 is partially obscured by the rear portion of the vehicle 10 and the trailer 12. Area 103 illustrates an improved viewable area when the reflective surface 19 of the left-side mirror 17 is moved to a second, or adjusted, position. Angling the reflective surface 19 of the mirror increases the usable viewable area to the side and the rear of the vehicle 10. FIG. 2 illustrates the vehicle 12 negotiating a left hand bend or curve, with an associated adjustment to the reflective surface 19 of the left-side mirror 17. If the vehicle 10 is negotiating a right hand bend or curve, the reflective surface 19 of the right-side mirror 17 could be positioned or adjusted to increase the viewable area in a manner similar to that shown in FIG. 2. While FIG. 2 illustrates an adjustment to the position of the reflective surface 19 of the left-side mirror 17 when the vehicle 10 negotiates a left hand bend or curve, adjustments could be made to the mirror 17 closest to the inside of the curve or to both mirrors 17 of the vehicle 10. Similarly, when the vehicle 10 negotiates a right hand bend or curve, adjustments could be made to the mirror 17 closes to the inside of the curve or to both mirrors 17 of the vehicle 10.

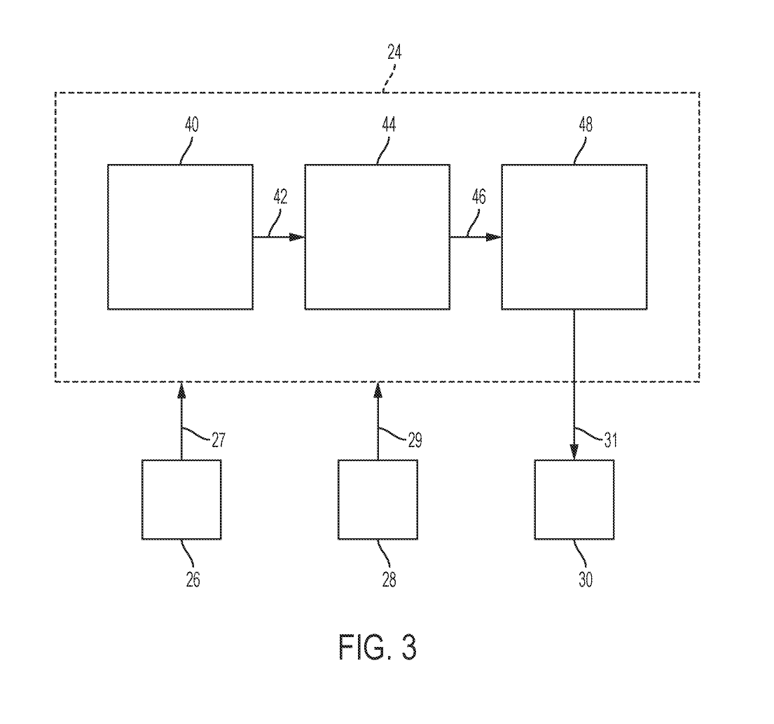

With reference to FIG. 3, the controller 22 includes a mirror positioning system 24 for calculating an adjustment to the position of the reflective surface 19 of the side-mounted rear view mirrors 17. In an exemplary embodiment, the mirror positioning system 24 is configured to receive information from the plurality of sensors 26 and/or the navigation system 28, analyze the sensor and/or the navigation input, determine whether the vehicle 10 has entered a turn or curve or if a turn or curve is upcoming on a predicted vehicle path, calculate an adjustment to a position of the reflective surface 19 of one or more of the mirrors 17 of the vehicle 10, and transmit a control signal to one or more actuators 30 to change the position of the reflective surface 19 of one or more of the mirrors 17.

The mirror positioning system 24 includes a sensor fusion module 40 for receiving input on vehicle characteristics, such as vehicle speed, steering angle, navigation data, or other vehicle characteristics. The sensor fusion module 40 is configured to receive input 27 from the plurality of sensors, such as the sensors 26 illustrated in FIG. 1, including information on the environment surrounding the vehicle 10, for example and without limitation, optical images capturing the area forward of the vehicle 10 in the direction of travel, RADAR images, and LIDAR images. Additionally, the sensor fusion module 32 receives navigation data 29 including longitude, latitude, and elevation information (e.g., GPS coordinates) from the navigation system 28.

The sensor fusion module 40 processes and synthesizes the inputs from the variety of sensors 26 and the navigation system 28 and generates a sensor fusion output 42. The sensor fusion output 42 includes various calculated parameters including, but not limited to, the vehicle location and whether the vehicle is negotiating a bend or curve or making a turn. In some embodiments, to determine whether the vehicle is negotiating a bend or curve or making a turn, the sensor fusion module 40 evaluates a steering angle provided by a steering angle sensor of the sensors 26 and determines whether the steering angle is above a predetermined steering angle threshold. In some embodiments, the predetermined steering angle threshold is above 45 degrees, above 50 degrees, above 60 degrees, above 75 degrees, or above 90 degrees. In some embodiments, the sensor fusion module 40 evaluates the navigation data to determine the location of the vehicle 10 and from map data accessed from off-board the vehicle via a wireless connection or accessed from an onboard map database stored within a controller of the vehicle 10, determines if the vehicle 10 is on or approaching a bend or curve. In some embodiments, for vehicles equipped with optical, RADAR, and LIDAR sensors, the sensor fusion module 40 evaluates the optical, RADAR, and LIDAR data provided by the sensors 26 and determines if the vehicle 40 is negotiating a bend or curve or making a turn.

With continued reference to FIG. 3, the mirror positioning system 24 also includes a calculation module 44 for calculating an adjustment to a position of the reflective surface 19 of one or more of the side-mounted rear view mirrors 17. In some embodiments, the calculated adjustment is based on sensor data received from the sensors 26, such as the steering angle of the vehicle 10 or gyroscopic data indicating that the vehicle 10 is negotiating a bend or curve or making a turn. In some embodiments, the calculated adjustment is based on navigation data indicating an upcoming bend or curve along the vehicle's projected path or a current bend on turn in the road based on the vehicle's current location, as discussed above.

In some embodiments, the adjustment to the position of the reflective surface 19 could be a predetermined number of degrees of rotation from an initial or first position. The initial or first position of the reflective surface 19 could be set by the operator as the primary position based on operator preferences. The calculation module 44 processes and synthesizes the sensor fusion output 42 to determine the adjustment in number of degrees and generates a calculation output 46. In some embodiments, the number of degrees of the adjustment to the position of the reflective surface 19 could be predetermined. For example, and without limitation, when the vehicle 10 begins a turn to the left, as determined by the sensor fusion module 40, the reflective surface 19 of the left-side mirror 17 could be adjusted or positioned by a predetermined amount to a second position. In some embodiments, the adjustment amount between the first position to the second position of the reflective surface 19 is within a calibratable range. The calibratable range could be determined by the calculation module 44 based on, for example and without limitation, a calculated radius of the turn, the type of vehicle, and an adjustable range of the reflective surface 19. In some embodiments, when the reflective surface 19 is in a neutral, or unadjusted position, the reflective surface 19 can be adjusted plus or minus (+/−) approximately 15 degrees, for a total possible adjustable range of approximately 30 degrees. For example, and without limitation, when the vehicle 10 negotiates a turn with a tighter or smaller radius, the calculation module 44 calculates a larger adjustment to the position of the reflective surface 19 of the mirror 19 than when the vehicle negotiates a turn with a larger radius. In some embodiments, the adjustment amount could be between about 1-15 degrees, between about 3-12 degrees, or between about 5-10 degrees. In some embodiments, the adjustment amount could be about 15 degrees, about 13 degrees, about 10 degrees, about 8 degrees, about 5 degrees, or about 2 degrees.

The mirror positioning system 24 further includes a positioning control module 48 for issuing control commands to vehicle actuators configured to adjust the position of the reflective surface 19 of one or more of the mirrors 17 from a first position to a second position. The positioning control module 48 is configured to receive the calculation output 46. The positioning control module 48 processes the calculation output 46 and generates an actuator control output 31. The actuator control output 31 is communicated to the actuators 30 and includes a set of actuator commands to position the reflective surface or surfaces 19 of the mirrors 17 based on the adjustment amount received from the calculation module 44.

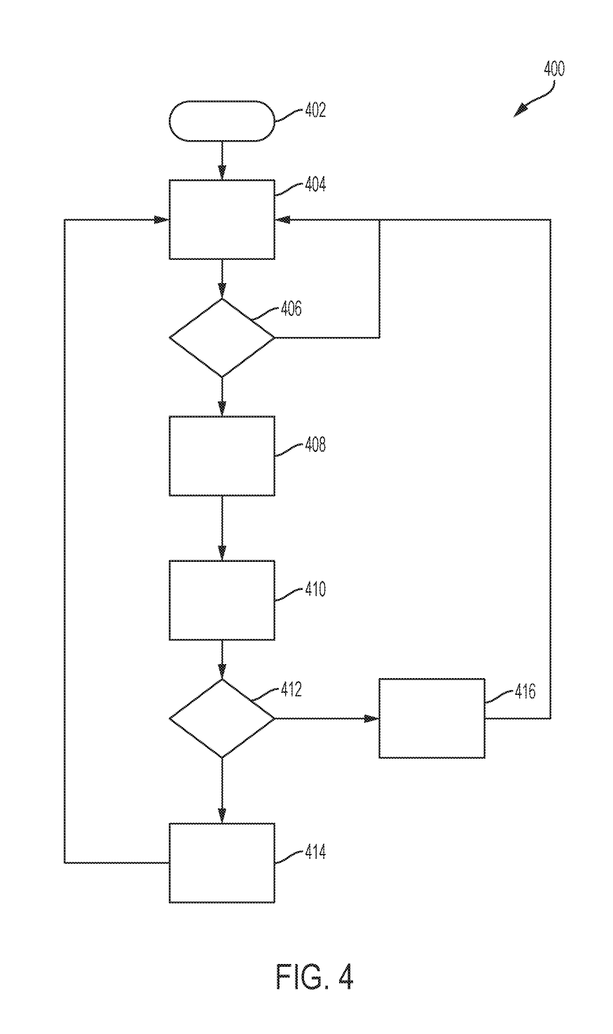

FIG. 4 is a flow chart of a method 400 illustrating the calculation of an adjustment to the position of the reflective surface 19 of one or more of the mirrors 17 and transmission of an actuator control signal to adjust the position of the reflective surface 19 based on the calculated adjustment. The calculation of the adjustment is based on one or more of the vehicle steering angle, navigation data indicating the vehicle location, gyroscopic data, and optical, RADAR, and/or LIDAR images of the area surrounding the vehicle. The vehicle steering angle, the gyroscopic data, and the optical, RADAR, and LIDAR images are obtained from the sensors 26 which include, in some embodiments, a steering angle sensor and/or a gyroscope and/or optical, RADAR, and LIDAR sensors. The navigation data is obtained from the navigation system 28. The method 400 can be utilized in connection with the vehicle 10, the controller 22, and the various modules of the mirror positioning system 24, in accordance with exemplary embodiments. The order of operation within the method 400 is not limited to the sequential execution as illustrated in FIG. 4, but may be performed in one or more varying orders as applicable and in accordance with the present disclosure.

As shown in FIG. 4, starting at 402, the method 400 proceeds to 404. At 404, the sensor fusion module 40 of the mirror positioning system 24 receives the sensor input and/or the navigation input indicating that the vehicle 10 is negotiating a bend or curve along the path of travel or is making a turn. The sensor input is received from the plurality of sensors 26, including one or more of a steering angle sensor, a gyroscope, and optical, RADAR, and LIDAR sensors, and the navigation data is received from the navigation system 28.

Next, at 406, the calculation module 44 determines whether the sensor data and/or the navigation data indicates that the vehicle 10 is negotiating a bend or curve or making a turn. If the sensor data and/or the navigation data indicates the vehicle 10 is not making a turn or negotiating a bend or curve, the method returns to 404 and the method 400 continues as follows.

If the sensor data and/or the navigation data indicates the vehicle 10 is making a turn or negotiating a bend or curve, the method proceeds to 408. At 408, the calculation module 44 determines whether to adjust the position of the reflective surface 19 of the left-side or right-side mirror 17 or whether to adjust the position of the reflective surfaces 19 of both of the mirrors 17. Additionally, the calculation module 44 calculates the amount of adjustment to move the reflective surface 19 from the first position to the second position. In some embodiments, a different amount of adjustment is determined for the left-side mirror and the right-side mirror.

Next, at 410, the positioning control module 48 generates an actuator control output 31. The actuator control output 31 is communicated to the actuators 30 and includes a set of actuator commands to change the position of the reflective surface 19 of the mirrors 17 from the first position to the second position based on the adjustment amount received from the calculation module 44.

The method proceeds to 412. At 412, the calculation module 44 determines whether the sensor data and/or the navigation data indicates that the vehicle 10 is no longer negotiating a bend or curve or making a turn. If the sensor data and/or the navigation data indicates the vehicle 10 is still making a turn or negotiating a bend or curve, the method 400 proceeds to 416 and no change is made to the position of the reflective surface 19 of the mirrors 17. The method 400 returns to 404 and the method 400 continues as discussed above.

However, if the calculation module 44 determines, at 412, that the vehicle 10 is no longer negotiating a bend or curve or making a turn, the positioning control module 48 generates an actuator control output 31, based on the calculation output 46, that includes a set of actuator commands to return the position of the reflective surface 19 to the initial or first position. The method 400 returns to 404 to continue the method as discussed above.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method to control a position of a reflective surface of a mirror of a vehicle, the method comprising:
providing the vehicle with at least one sensor configured to measure at least one vehicle characteristic and a controller in electronic communication with the at least one sensor;
receiving, by the controller, vehicle data corresponding to the at least one vehicle characteristic from the at least one sensor;
calculating, by the controller, a reflective surface adjustment based on the vehicle data; and
automatically controlling, by the controller, the actuator to change the position of the reflective surface of the mirror from a first position to a second position based on the reflective surface adjustment.

2. The method of claim 1 further comprising determining, by the controller, whether the vehicle is negotiating a turn based on the vehicle data.

3. The method of claim 1, wherein the at least one sensor includes a steering angle sensor and the vehicle data is a steering angle of the vehicle.

4. The method of claim 1, wherein the at least one sensor includes a gyroscope and the vehicle data is gyroscopic data of the vehicle.

5. The method of claim 1, wherein the at least one sensor includes one or more of an optical, RADAR, and LIDAR sensor and the vehicle data includes one or more of optical, RADAR, and LIDAR images of an environment surrounding the vehicle.

6. The method of claim 1 further comprising receiving, by the controller, navigation data corresponding to a location of the vehicle and determining, by the controller, whether the vehicle is negotiating a turn based on the navigation data.

7. The method of claim 1, wherein the reflective surface adjustment is a predetermined value.

8. The method of claim 2 further comprising determining, by the controller, whether the vehicle has completed negotiation of the turn based on the vehicle data and automatically controlling, by the controller, the actuator to change the position of the reflective surface of the mirror from the second position to the first position.

9. An automotive vehicle, comprising:
a vehicle steering system;
at least one sensor electrically connected to the vehicle steering system and configured to measure at least one vehicle characteristic;
a mirror coupled to a side of the vehicle, the mirror including a housing and a reflective surface selectively positionable between a first position and a second position;
an actuator in communication with the reflective surface of the mirror; and
a controller in communication with the sensor and the actuator, the controller configured to
receive vehicle data corresponding to at least one vehicle characteristic from the at least one sensor;
calculate a reflective surface adjustment based on the vehicle data; and
automatically control the actuator to change the position of the reflective surface of the mirror from a first position to a second position based on the reflective surface adjustment.

10. The automotive vehicle of claim 9, wherein the at least one sensor includes one or more of a steering angle sensor, a gyroscope, an optical sensor, a RADAR sensor, and a LIDAR sensor.

11. The automotive vehicle of claim 9, wherein the controller is further configured to determine whether the vehicle is negotiating a turn based on the vehicle data.

12. The automotive vehicle of claim 9, wherein the reflective surface adjustment is a predetermined value.

13. The automotive vehicle of claim 11, wherein the controller is further configured to determine whether the vehicle has completed negotiation of the turn based on the vehicle data and automatically control the actuator to change the position of the reflective surface of the mirror from the second position to the first position.

14. A system for automatically adjusting a reflective surface of a vehicle mirror, comprising:
an actuator configured to control a position of the reflective surface of the vehicle mirror, the reflective surface selectively positionable between a first position and a second position;
a sensor configured to measure a vehicle characteristic; and
a controller in communication with the actuator and the sensor, the controller configured to automatically control the actuator to change a position of the reflective surface from the first position to the second position based on the measured vehicle characteristic.

15. The system of claim 14, wherein the sensor is a steering angle sensor configured to measure a vehicle steering angle.

16. The system of claim 15, wherein the controller is further configured to determine whether the vehicle is negotiating a turn based on the steering angle.

17. The system of claim 15, wherein the controller is further configured to calculate a reflective surface adjustment based on the steering angle.

18. The system of claim 17, wherein the reflective surface adjustment is a predetermined value.

19. The system of claim 16, wherein the controller is further configured to determine whether the vehicle has completed negotiation of the turn based on the measured vehicle characteristic and automatically control the actuator to change the position of the reflective surface of the mirror from the second position to the first position.
